(19) United States
(12) Patent Application Publication
(10) Pub. No.: US 2017/0329969 A1
(43) Pub. Date: Nov. 16, 2017

(54) INFORMATION PROCESSING DEVICE AND COMPUTER PROGRAM PRODUCT

(71) Applicants: Norihiko MURATA, Tokyo (JP); Shoichiro KANEMATSU, Kanagawa (JP)

(72) Inventors: Norihiko MURATA, Tokyo (JP); Shoichiro KANEMATSU, Kanagawa (JP)

(21) Appl. No.: 15/652,443

(22) Filed: Jul. 18, 2017

Related U.S. Application Data
(63) Continuation of application No. PCT/JP2016/000414, filed on Jan. 27, 2016.

(30) Foreign Application Priority Data
Jan. 28, 2015 (JP) 2015-014364

(51) Int. Cl. G06F 21/57; G06F 9/445; G06F 21/44

(52) U.S. Cl. CPC G06F 21/57; G06F 21/44; G06F 8/65; G06F 9/445; G06F 2221/033

(57) ABSTRACT

An information processing device includes an execution program management unit and an update unit. The execution program management unit includes an update permission unit configured to permit update of software. The execution program management unit permits the update permission unit to execute the update of the software, and gives, to the software, an update authority so that the update permission unit obtains permission for the update of the software. The update unit is started by the software to which the update authority has been given by the execution program management unit. The update unit receives, from an external device, an updating file for updating the software, and registers the received updating file in a whitelist to update the software.

### CROSS-REFERENCE TO RELATED APPLICATIONS

This application is a continuation of PCT international Application Ser. No. PCT/JP2016/000414, filed on Jan. 27, 2016, which designates the United States and which claims the benefit of priority from Japanese Patent Application No. 2015-014364, filed on Jan. 28, 2015; the entire contents of which are incorporated herein by reference.

### BACKGROUND OF THE INVENTION

### 1. Field of the Invention

The present invention relates to an information processing device and a computer program product.

### 2. Description of the Related Art

Conventionally, there have been various types of antivirus software to prevent a cyber attack on a device connected to a network. Among them, there is so-called whitelist-type antivirus software that permits access only by known programs and restricts access by other programs. The whitelist-type antivirus software is capable of registering only reliable applications in a whitelist, whereby execution of applications which have not been registered in the whitelist can be blocked.

In the whitelist-type antivirus software, however, on each occasion that an additional function or correction of malfunction is generated for an operating system (OS), which is a basic system of a device, or for various types of applications which operate on that OS, it is necessary to register, in the whitelist, a program (hereinafter referred to as an update program) for adding the function to/correcting the malfunction of the application. It is also necessary to register, in the whitelist, an execution file for executing the OS or application to be newly generated by executing that update program. In order to decrease such a workload, Japanese Unexamined Patent Application Publication No. 2014-096141, for example, discloses a technique to permit a program to be started and register the program in a whitelist when the program satisfies a predetermined criterion. The predetermined criterion includes, for example, that a program to be started has been issued by a reliable issuer.

In Japanese Unexamined Patent Application Publication No. 2014-096141, however, work by a user has still been required due to necessity of setting in advance the above-mentioned predetermined criterion and determining to register a program in a whitelist. Meanwhile, it is possible to recreate the whitelist itself every time the update program is issued. However, it takes time to create the whitelist, and to restart the OS or application for reflecting therein the created whitelist. As a result, there has been a problem that an operation rate of a device is reduced.

### SUMMARY OF THE INVENTION

According to one aspect of the present invention, an information processing device includes an execution program management unit and an update unit. The execution program management unit includes an update permission unit configured to permit update of software. The execution program management unit permits the update permission unit to execute the update of the software, and gives, to the software, an update authority so that the update permission unit obtains permission for the update of the software. The update unit is started by the software to which the update authority has been given by the execution program management unit. The updated unit receives, from an external device, an updating file for updating the software, and registers the received updating file in a whitelist to update the software.

### BRIEF DESCRIPTION OF THE DRAWINGS

FIG. 1 is a diagram illustrating an exemplary configuration of an information processing system to which an information processing device, a program, and a recording medium according to the present invention have been applied;

FIG. 2 is a diagram illustrating a hardware configuration of the information processing device illustrated in FIG. 1,

FIG. 3 is a diagram illustrating an exemplary configuration of a whitelist;

FIG. 4 is a block diagram illustrating a functional configuration of the information processing device;

FIG. 5 is a diagram illustrating a hardware configuration of a system update server illustrated in FIG. 1;

FIG. 6 is a block diagram illustrating a functional configuration of the system update server;

FIG. 7 is a diagram illustrating an exemplary update menu screen;

FIG. 8 is a diagram illustrating an exemplary update-via- network screen;

FIG. 9 is a diagram illustrating an exemplary update-via-USB screen;

FIG. 10 is a diagram illustrating an exemplary ZIP file for updating an application program illustrated in FIG. 8 or 9;

FIG. 11 is a diagram illustrating an exemplary ZIP file for updating an OS illustrated in FIG. 8 or 9;

FIG. 12 is a diagram illustrating an exemplary batch file illustrated in FIG. 11;

FIG. 13 is a flowchart illustrating a process procedure for update process in the system;

FIG. 14 is an image diagram illustrating an exemplary process to obtain a list of update programs;

FIG. 15 is an image diagram illustrating an exemplary process to obtain the ZIP file; and

FIG. 16 is a flowchart illustrating a process procedure for system update process.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An object of an embodiment is to provide an information processing device capable of decreasing a workload that accompanies an update of software without reducing an operation rate of a device.

Hereinafter, an embodiment of an information processing device, a program, and a recording medium according to the present invention will be described in detail referring to the accompanying drawings.

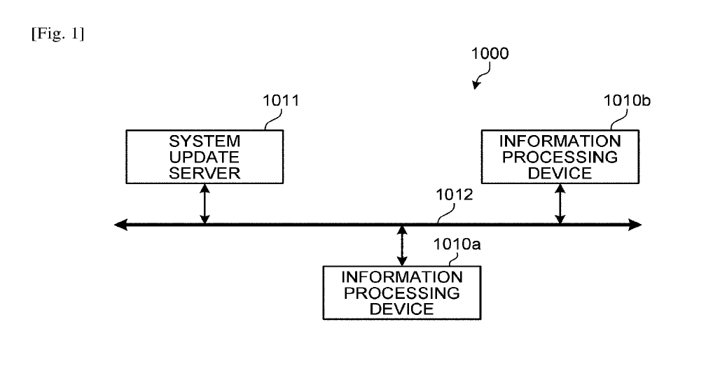

FIG. 1 is a diagram illustrating an exemplary configuration of an information processing system 1000 to which the information processing device, the program, and the recording medium according to the present invention have been applied. As illustrated in FIG. 1, the information processing system 1000 includes one or more information processing devices (information processing device 1010a and information processing device 1010b) and a system update server 1011 coupled to each other via a network 1012. The network 1012 is a general network such as a local area network (LAN) and the Internet. The network 1012 sends/receives a variety of data between the information processing devices and system update server 1011. Hereinafter, the information processing devices will be simply referred to as the information processing device 1010.

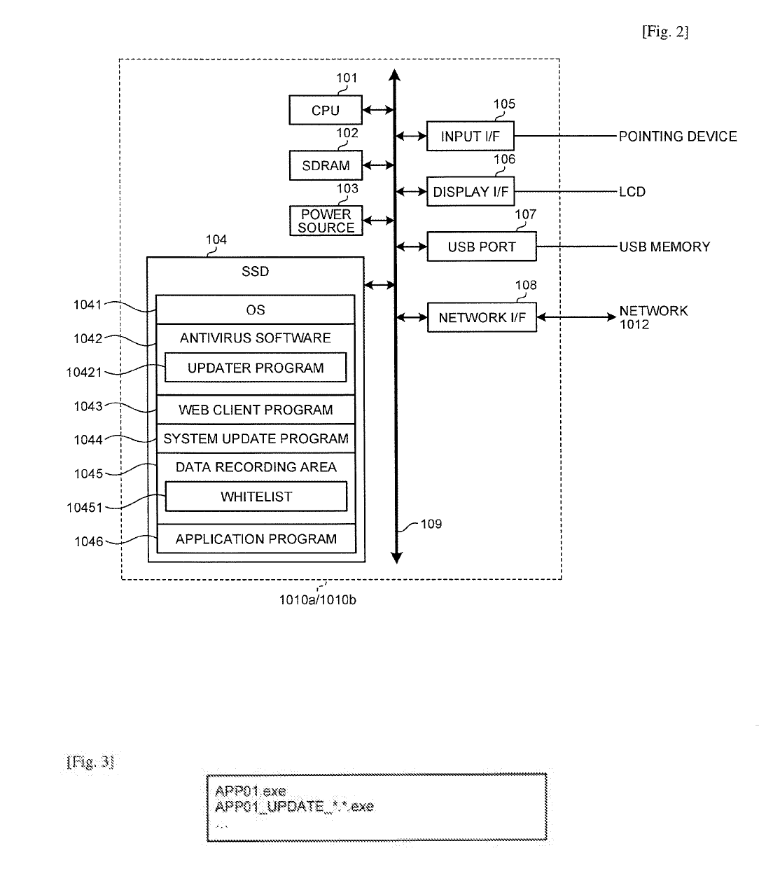

FIG. 2 is a diagram illustrating a hardware configuration of the information processing device 1010 illustrated in FIG. 1. As illustrated in FIG. 2, the information processing device 1010 includes a central processing unit (CPU) 101, a synchronous dynamic random access memory (SDRAM) 102, a power source 103, a solid state drive (SSD) 104, an input interface (hereinafter abbreviated as I/F) 105, a display I/F 106, a universal serial bus (USB) port 107, and a network I/F 108, coupled to one another via a bus 109.

The CPU 101 is a calculating device that processes and controls various programs stored in the SSD 104. The SDRAM 102 is a work area for the CPU 101. The SDRAM 102 is also a storage medium for allowing various applications or an operating system (OS) stored in the SSD 104 to reside therein. The SSD 104 is a storage device that stores various types of programs for causing the OS or various applications to operate on the information processing device 1010. Hereinafter, the OS and the application are included in what is sometimes simply referred to as software.

The input I/F 105 is an interface for connecting thereto a pointing device such as a mouse and a touch sensor. The display I/F 106 is an interface for connecting thereto a display device. The USB port 107 is a port provided for connecting thereto various external devices. The network I/F 108 is an interface for controlling connection with the network 1012. The network I/F 108 also controls communication between the information processing devices via the network 1012, and that between the information processing device and the system update server 1011 via the network 1012. Next, data stored in the SSD 104 will be described.

The SSD 104 stores therein an OS 1041, antivirus software 1042, a web client program 1043, a system update program 1044, a whitelist 10451, and an application program 1046. The whitelist 10451 is recorded in a data recording area 1045 inside the SSD 104.

The OS 1041 is a general operating system that operates the information processing device 1010. For example, Microsoft Windows Embedded Standard 7 (registered trademark) can be used as the OS 1041.

The antivirus software 1042 is whitelist-type antivirus software for detecting and removing a virus. For example, McAfee Embedded Control (registered trademark) can be used as the antivirus software 1042. The antivirus software 1042 recognizes only a file registered in the whitelist 10451 as an executable file, and permits that file to be executed.

The antivirus software 1042 also has an updater (hereinafter referred to as an updater program) 10421 which permits an appropriate update for adding software or updating a software version.

When updating the OS 1041, for example, the antivirus software 1042 updates a system configuration of the information processing device 1010 to change a setting thereof so as to permit the updater program 10421 to be executed. Specifically, the antivirus software 1042 executes a command “finetune add U-WindowsUpdate”. By executing this command, the updater program 10421, which is not permitted to be executed in a normal state, is allowed to be executed when updating the OS 1041. Although the following description will refer to a case where the OS 1041 is updated, the description can be applied to other software.

The antivirus software 1042 gives, to the application program 1046, an authority (hereinafter referred to as an updater authority) for obtaining permission to update (for example, add a new application program to or delete/change) the application program 1046 itself. Specifically, the antivirus software 1042 executes a command “sadmin updaters add APP01.exe”. The “APP01.exe” is an example of the application program 1046. By executing this command, the application program 1046 is allowed to be updated. Although the following description will refer to a case where the application program 1046 is updated, the description can be applied to other software.

Upon receiving a notification from the system update program 1044, the antivirus software 1042 registers various files in the whitelist 10451 and updates a content of the whitelist 10451. Such various files include, for example, an executable file which is required for updating the OS 1041 or application program 1046.

The web client program 1043 is a client program for sending a request to and receiving a response from a web server program 4042 through a hyper text transfer protocol (HTTP). The web server program 4042 is stored in the system update server 1011.

The system update program 1044 is a program for updating the OS 1041 or application program 1046 installed in the information processing device 1010 by using an update program for the OS or application. The update program is downloaded from the system update server 1011, or read from a USB memory connected to the USB port 107.

The whitelist 10451 is a list to store the executable file. FIG. 3 is a diagram illustrating an exemplary configuration of the whitelist 10451. As illustrated in FIG. 3, the executable files, which are permitted to be executed, are stored in the whitelist 10451 in a list format. In FIG. 3, it is illustrated that execution of the application program 1046 (APP01.exe) and execution of an update program for the OS 1041 (APP01_UPDATE_*.*.exe, where *.* is any single-byte alphanumeric character), are registered. It is also illustrated that these programs are permitted to be executed.

The application program 1046 is a program for executing a general application that operates on the OS 1041.

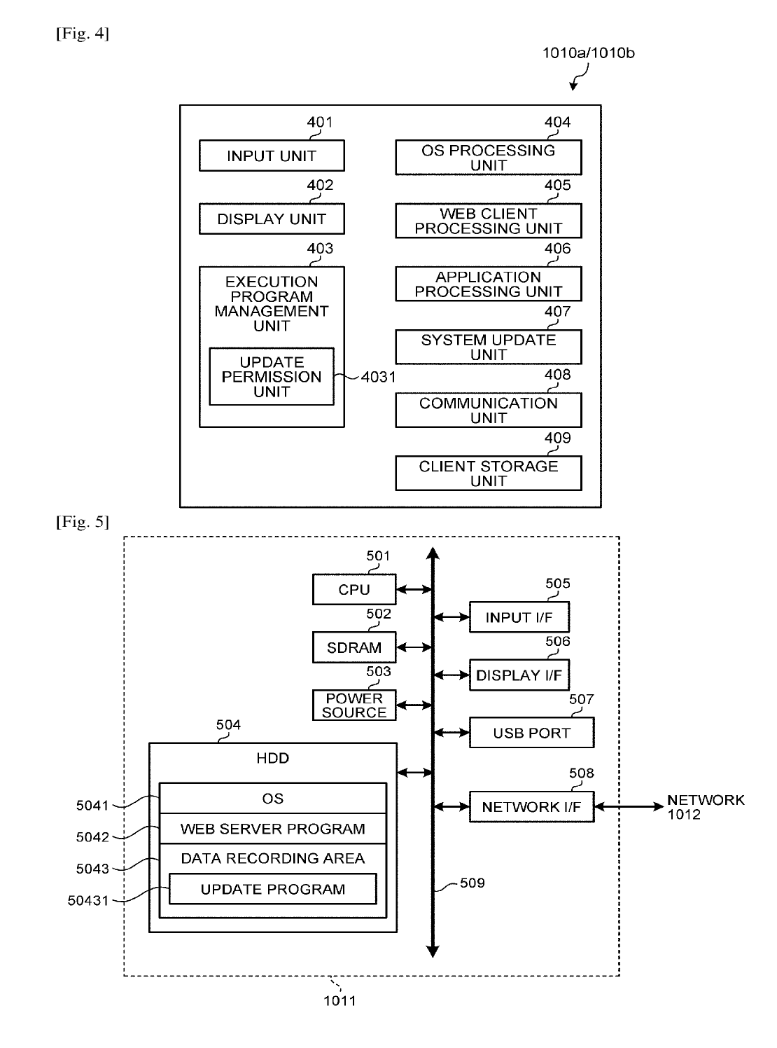

FIG. 4 is a block diagram illustrating a functional configuration of the information processing device 1010. As illustrated in FIG. 4, the information processing device 1010 functionally has an input unit 401, a display unit 402, an execution program management unit 403, an OS processing unit 404, a web client processing unit 405, an application processing unit 406, a system update unit 407, a communication unit 408, and a client storage unit 409.

The input unit 401 serves a function of the input I/F 105 and receives input from the pointing device. The display unit 402 serves a function of the display I/F 106 and displays various information on an LCD. The execution program management unit 403 serves a function of the antivirus software 1042 and does not permit a program, which is not registered in advance in the whitelist 10451, to be executed. The execution program management unit 403 registers the executable file notified by the system update unit 407 in the whitelist to update the content of the whitelist. An update permission unit 4031 serves a function of the updater program 10421 and permits the update for adding the software or updating the software version.

The OS processing unit 404 serves a function of the OS 1041 and operates the information processing device 1010. The web client processing unit 405 serves a function of the web client program 1043 and sends the request to and receive the response from the system update server 1011 through the HTTP. The application processing unit 406 serves a function of the application program 1046 and executes the general application. The system update unit 407 serves a function of the system update program 1044 and updates the OS 1041 or the application program 1046 by using the above-mentioned update program. The system update unit 407 also generates the above-mentioned request.

The communication unit 408 corresponds to the USB port 107 and network I/F 108 and performs communication between the information processing device 1010 and the external device connected to the information processing device 1010. The client storage unit 409 serves a function of the SSD 104 and stores therein each program for operating or updating the above-mentioned OS or various applications. Next, returning to FIG. 1, the system update server 1011 will be described.

FIG. 5 is a diagram illustrating a hardware configuration of the system update server 1011 illustrated in FIG. 1. As illustrated in FIG. 5, the system update server 1011 includes a CPU 501, an SDRAM 502, a power source 503, a hard disk drive (HDD) 504, an input I/F 505, a display I/F 506, a USB port 507, and a network I/F 508, coupled to one another via a bus 509. Among the respective components of the system update server 1011, components other than the HDD 504 are similar to those of the information processing device 1010. Therefore, a description of the HDD 504 will be given hereinafter while omitting descriptions of the other components.

The HDD 504 stores therein an OS 5041, a web server program 5042, and an update program 50431 recorded in a data recording area 5043. The HDD 504 further stores therein, as a history, the latest and previous versions of the OS 1041 or application program 1046.

The OS 5041 is a general operating system that operates the system update server 1011. For example, Microsoft Windows Server 2008 Enterprise Edition R2 (registered trademark) can be used as the OS 5041.

The web server program 5042 determines, based on an update request, whether there is the application program 1046 or OS 1041 to be updated. The update request is a request issued from the information processing device 1010 for updating the OS 1041 or the application program 1046. When the web server program 5042 determines that there is the application program 1046 or OS 1041 to be updated, the web server program 5042 sends an update program 50431 to the information processing device 1010 which is a requester.

The update program 50431 is an update program for the OS 1041 and application program 1046 installed in the information processing device 1010. The update program 50431 includes, for example, a version update program and a patch program for the OS 1041 and the application program 1046.

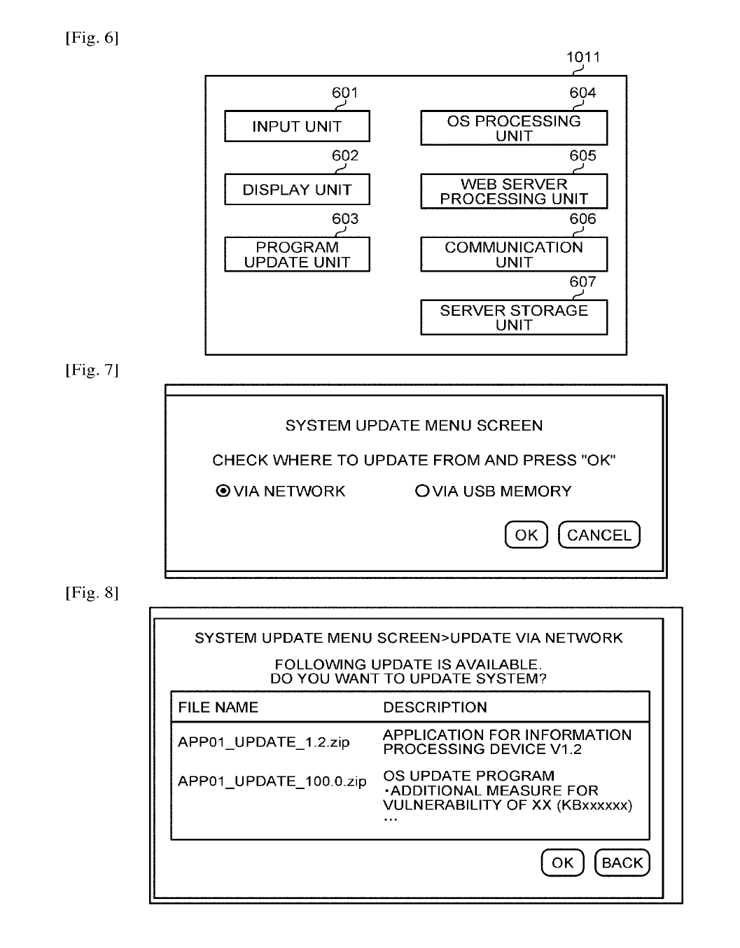

FIG. 6 is a block diagram illustrating a functional configuration of the system update server 1011. As illustrated in FIG. 6, the system update server 1011 functionally has an input unit 601, a display unit 602, a program update unit 603, an OS processing unit 604, a web server processing unit 605, a communication unit 606, and a server storage unit 607. Since the input unit 601, the display unit 602, and the communication unit 606 are similar to those of the information processing device 1010, descriptions of them will be omitted herein.

The program update unit 603 serves a function of the update program 50431 and generates a ZIP file in which the update program 50431 for the system update program 1044 held by the information processing device 1010 is recorded. The OS processing unit 604 operates the system update server 1011. The web server processing unit 605 determines, based on the update request, whether the application program 1046 or OS 1041 to be updated is stored in the system update server 1011. The web server processing unit 605 also sends the ZIP file including the update program 50431 to the information processing device 1010 which is a requester. The server storage unit 607 serves a function of the HDD and stores therein the above-mentioned each program.

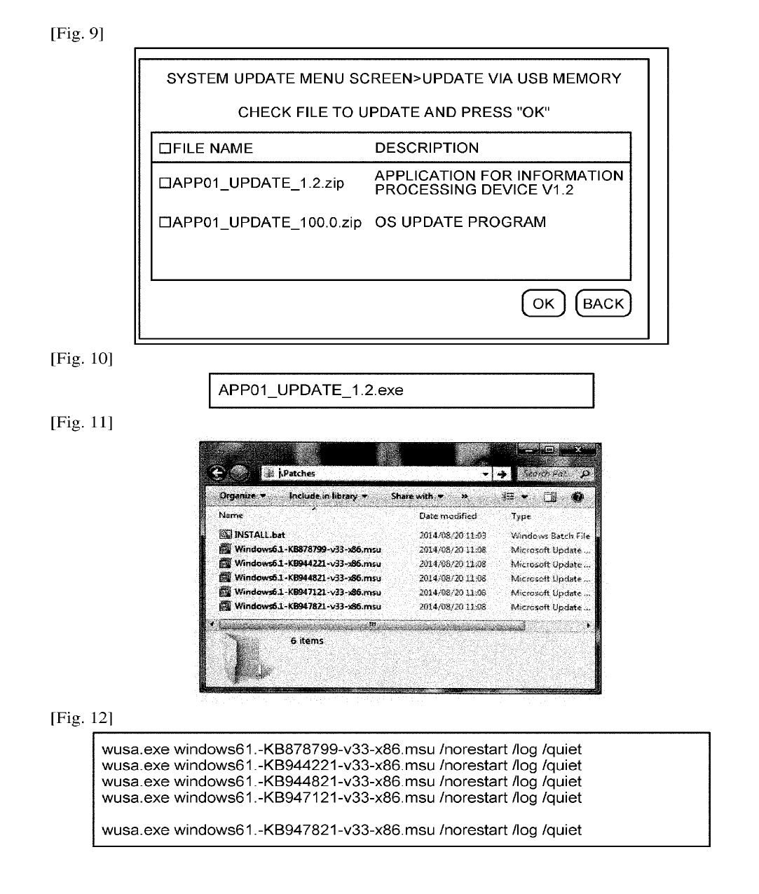

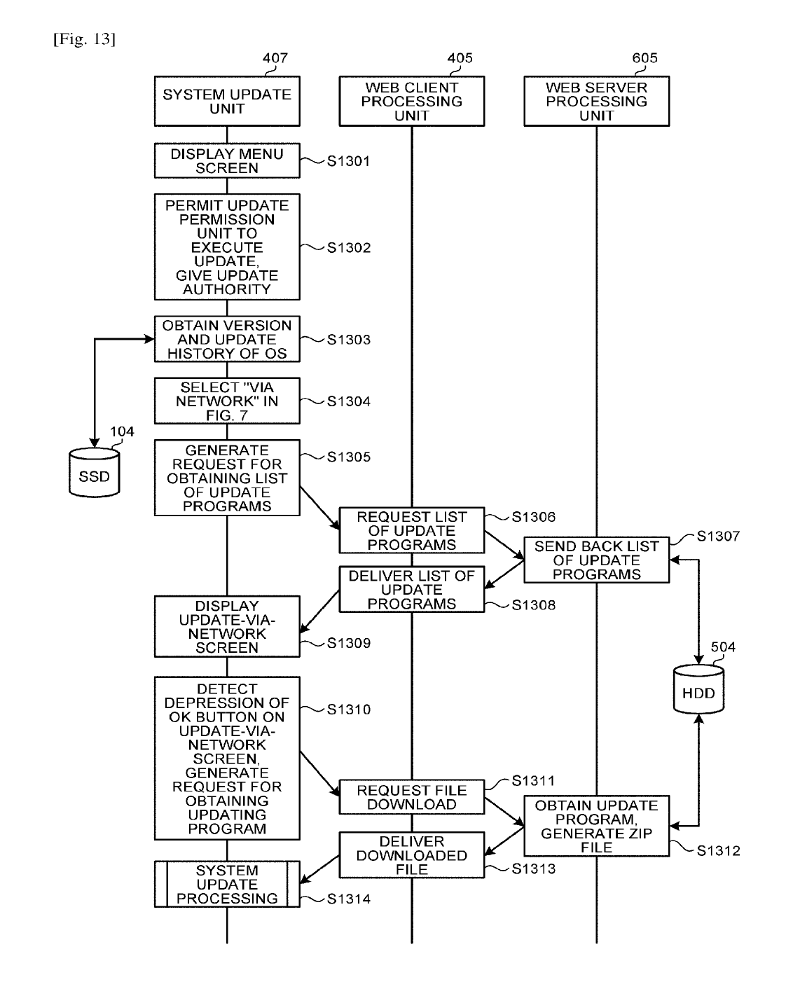

FIG. 7 is a diagram illustrating an exemplary update menu screen for updating the OS 1041 or the application program 1046 by the update program 50431. The update menu screen is displayed on the display unit 402 of the information processing device 1010. As illustrated in FIG. 7, a menu for selecting either an update via network or an update by USB is displayed on the update menu screen. The update menu screen is displayed by the system update unit 407. The input unit 401 accepts a selection of either “via USB memory” or “via network” and accepts depression of an OK button. The system update unit 407 then displays either an update-via-network screen illustrated in FIG. 8 or an update-via-USB screen illustrated in FIG. 9.

FIG. 8 is a diagram illustrating an exemplary update-via-network screen. As illustrated in FIG. 8, a file name and a description are associated with each other and displayed on the update-via-network screen. The file name indicates a program for software to be updated. The description indicates a summarized content of the file. In FIG. 8, for example, a ZIP file named “APP01_UPDATE_1.2.zip” indicates that the application program 1046 installed in the information processing device 1010 is version 1.2. The update-via-network screen is displayed by the system update unit 407. When the input unit 401 accepts depression of an OK button displayed on this screen, the system update unit 407 executes the update of the software.

FIG. 9 is a diagram illustrating an exemplary update-via-USB screen. As illustrated in FIG. 9, a file name and a description thereof are associated with each other and displayed on the update-via-USE screen. The file name indicates a program for software to be updated. The description indicates a summarized content of the file. In FIG. 9, in the same way as FIG. 8, the file name indicating the program for the software to be updated and the description indicating the summarized content of the file are displayed in association with each other. The update-via-USB screen is displayed by the system update unit 407. In the same way as FIG. 8, when the input unit 401 accepts depression of an OK button displayed on this screen, the system update unit 407 executes the update of the software.

A checkbox associated with each item is provided in this screen. When the input unit 401 accepts a check in the checkbox, the system update unit 407 executes the update of the OS 1041 or application program 1046 corresponding to that check.

FIG. 10 is a diagram illustrating an exemplary ZIP file for updating the application program 1046 illustrated in FIG. 8 or 9. As illustrated in FIG. 10, the ZIP file includes an executable file named “APP01_UPDATE x.x.exe”. “x.x” is a version number of the application program 1046 installed in the information processing device 1010. The system update unit 407 is started from the application program 1046 (APP01.exe), receives the above-mentioned ZIP file as a parameter, and extracts the ZIP file, thereby updating the application program 1046.

FIG. 11 is a diagram illustrating an exemplary ZIP file for updating the OS 1041 illustrated in FIG. 8 or 9.

As illustrated in FIG. 11, the ZIP file includes a batch file “INSTALL.bat” and the update program 50431 for the OS 1041. The batch file “INSTALL.bat” is a batch file in which a procedure for the system update unit 407 to update the OS 1041 is described. A file with an extension “.msu” is the update program for the OS 1041.

FIG. 12 is a diagram illustrating an exemplary batch file illustrated in FIG. 11. In the batch file, as illustrated in FIG. 12, the update programs 50431 are listed in execution order. Processes to install the exemplary update programs 50431 in order from “windows61.-KB878799-v33-x86.msu” to “windows61.-KB947821-v33-x86.msu” is illustrated in FIG. 12. Next, processes to be executed in the present system will be described.

FIG. 13 is a flowchart illustrating a process procedure for update process when updating the OS or the application in the present system.

As illustrated in FIG. 13, the system update unit 407 displays the menu screen illustrated in FIG. 7 on the display unit 402 (S1301). Timing of displaying the menu screen is, for example, when the application program 1046 or the OS 1041 is started. The system update program 1044 is also called at the same timing.

The execution program management unit 403 permits the update permission unit 4031 to execute the update of the OS 1041 and gives, to the application program 1046, the updater authority so that the update permission unit 4031 obtains permission for the update of the application program 1046 (S1302). When the updater authority is given to the application program 1046, the updater authority is also passed on to the system update unit 407 which is called by that application program 1046. The system update unit 407 is then allowed to update the OS 1041 or the application program 1046. While the step S1302 has been directed to the application program 1046, the same applies to the OS 1041.

The system update unit 407 refers to a registry and the SSD 104 to obtain an update history of the OS 1041 and current version information of the application program 1046 installed in the information processing device 1010 (S1303). For example, the system update unit 407 obtains a current version number “1.0” of the application program 1046.

The input unit 401 accepts the selection “via network” from the menu screen illustrated in FIG. 7 (S1304). The web client processing unit 405 accesses the system update server 1011 to obtain a list of the update programs in relation to the OS 1041 and the application program 1046 (S1305). The following description will be directed to an exemplary case where the software is updated via the network.

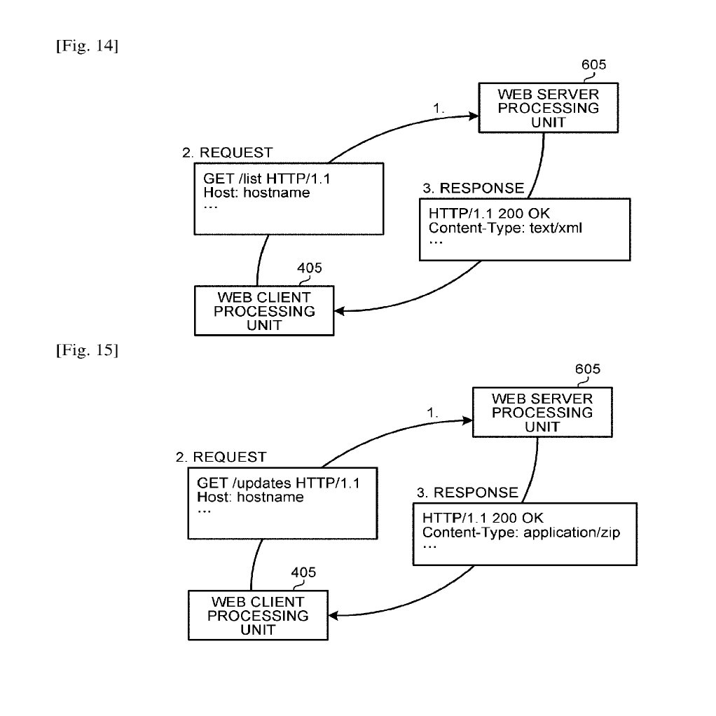

FIG. 14 is an image diagram illustrating an exemplary process to obtain the list of the update programs. First, as illustrated in FIG. 14, 1) a TCP session is established through the HTTP from the web client processing unit 405 to the web server processing unit 605. Next, 2) the web client processing unit 405 sends, to the web server processing unit 605, a request message for obtaining the list of the update programs 50431. Furthermore, 3) the web server processing unit 605 sends a response message back to the web client processing unit 405. According to these three procedures, the list of the update programs 50431 is obtained.

The web client processing unit 405 and the web server processing unit 605 use a GET method of the HTTP in order to execute the above-mentioned request and response. Specifically, “/list” is designated as a pass. As a body parameter, the version number of the application program 1046 currently installed in the information processing device 1010 and the update program 50431 for the OS 1041 are described in an extensible markup language (XML) format.

The system update unit 407 generates the above-mentioned pass and body parameter and delivers them to the web client processing unit 405. The web client processing unit 405 then executes the above-mentioned three procedures with the web server processing unit 605. As a result, the list of the update programs 50431 is obtained. Next, returning to FIG. 13, step S1304 and subsequent steps will each be described.

As described above, the system update unit 407 generates the request for the list of the update programs 50431 (S1305). The web client processing unit 405 then sends that request to the system update server 1011 by the GET method (S1306).

The web server processing unit 605 retrieves the latest version of the application program 1046 (for example, the application program 1046 with the greatest version number) installed in advance in the HDD 504. The web server processing unit 605 then determines whether that version number is greater than the version number of the application program 1046 designated by the above-mentioned XML. When that version number is determined to be greater, the web server processing unit 605 obtains a file name of the latest version of the application program 1046.

For example, in a case where three application programs 1046 with version numbers 1.0, 1.1, and 1.2 are stored in the HDD 504, a retrieval result by the web server processing unit 605 is the version 1.2. In this case, since the version number 1.2 is greater than the current version number 1.0 obtained by the system update unit 407, the web server processing unit 605 describes the file name

“APP01_UPDATE_1.2.zip” in the response. The web server processing unit 605 also retrieves the update program 50431 for the OS 1041 which is not included in the above-mentioned XML. The web server processing unit 605 then describes, in the above-mentioned response message, the update programs 50431 in a list format.

By performing such processing, the web server processing unit 605 describes, in the response message, the file name of the update program 50431 for the OS 1041 and the application program 1046 in the XML format. The web server processing unit 605 then sends the response message to the web client processing unit 405 (S1307).

The web client processing unit 405 delivers, to the system update unit 407, the XML described in the above-mentioned response message received from the web server processing unit 605 (S1308). The system update unit 407 refers to the list of the update programs 50431 described in the response message received from the web client processing unit 405. The system update unit 407 then displays the update-via-network screen illustrated in FIG. 8 on the display unit 402 (S1309).

Regarding the update program for the OS 1041 displayed on the update-via-network screen illustrated in FIG. 8, a fixed file name “APP01_UPDATE_100.0.zip” is given to a column “file name”, and a breakdown of the update program 50431 is given to a column “description”. A file group illustrated in FIG. 11 is zip-compressed into a ZIP file “APP01_UPDATE_100.0.zip”. The ZIP file “APP01_UPDATE_100.0.zip” is generated by the web server processing unit 605 and described in the XML together with the file name and breakdown.

When the input unit 401 accepts the depression of the OK button on the update-via-network screen, the system update unit 407 refers to the file name of the application program 1046 or OS 1041 displayed on the update-via-network screen to generate the request for an entity file of each software (S1310). The web client processing unit 405 sends that request to the system update server 1011 by the GET method (S1311).

The web server processing unit 605 refers to the file name of the application program 1046 or OS 1041 described in the request to obtain the ZIP file of the entity file of the update program. The ZIP file has been generated in advance by the program update unit 603 and stored in the HDD 504. The entity file is, for example, “APP01_UPDATE_1.2.zip” and the update program (.msu) for the OS 1041. The web server processing unit 605 then creates the batch file “INSTALL.bat” and generates the ZIP file “APP01_UPDATE_100.0.zip” including the “INSTALL.bat” file and the update program. The web server processing unit 605 further sends the ZIP file “APP01_UPDATE_100.0.zip” to the web client processing unit 405 (S1312). Next, a process to obtain the ZIP file will be described.

FIG. 15 is an image diagram illustrating an exemplary process to obtain the ZIP file. As illustrated in FIG. 15, in the same way as illustrated in FIG. 14, 1) the TCP session is established through the HTTP from the web client processing unit 405 to the web server processing unit 605. Next, 2) the web client processing unit 405 sends, to the web server processing unit 605, a request message for obtaining the update program 50431. Furthermore, 3) the web server processing unit 605 sends a response message back to the web client processing unit 405. According to these three procedures, the above-mentioned entity file of the update program, namely the ZIP file is obtained.

In the same way as illustrated in FIG. 14, the web client processing unit 405 and the web server processing unit 605 use the GET method of the HTTP in order to execute the above-mentioned request and response. Specifically, “/updates” is designated as the pass. As the body parameter, the file name of the application program 1046 or OS 1041, the update of which is requested, is described in the extensible markup language (XML) format. Next, returning to FIG. 13, step S1313 and subsequent steps will each be described.

The web client processing unit 405 delivers, to the system update unit 407, the XML described in the response message received from the web server processing unit 605 (S1313). The system update unit 407 reads the ZIP file described in the response message received from the web client processing unit 405. The system update unit 407 then executes system update processing to update the OS 1041 or the application program 1046 (S1314).

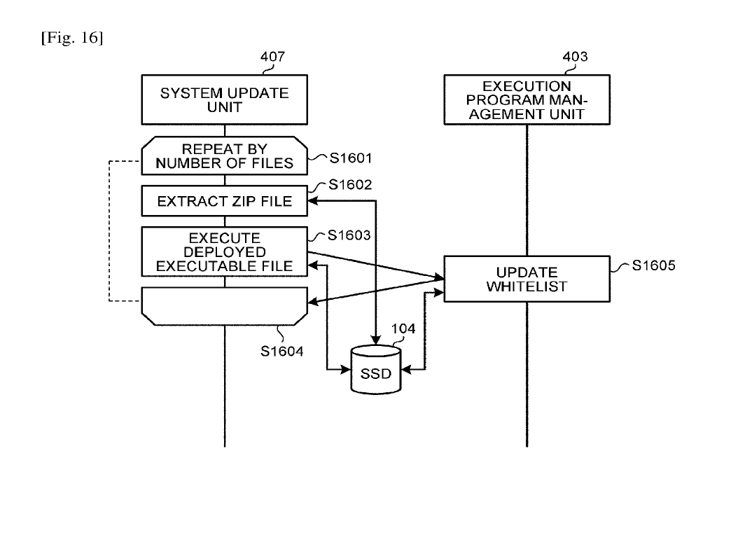

FIG. 16 is a flowchart illustrating a process procedure for the system update process. This process is executed repeatedly by the number of update programs 50431 included in the read ZIP file (S1601, S1604).

First, as illustrated in FIG. 16, the system update unit 407 unzips and extracts the read ZIP file (S1602). For example, the system update unit 407 unzips “APP01_UPDATE_1.2.zip” to extract the application program 1046 represented by “APP01_UPDATE_1.2.exe” . The system update unit 407 also unzips “APP01_UPDATE_100.0.zip” to extract each executable file described in FIG. 8.

The system update unit 407 executes each extracted executable file (S1603). In this case, the system update unit 407 notifies the execution program management unit 403 of each executable file. The execution program management unit 403 then registers, in the whitelist 10451, each executable file notified as mentioned above, and updates the content of the whitelist 10451 (S1605). Next, the system update unit 407 executes each executable file registered as mentioned above in the whitelist 10451. The system update unit 407 thus updates the OS 1041 or the application program 1046.

Therefore, the present system, which executes the above-mentioned processing, can decrease a workload that accompanies the update of the software such as the OS 1041 and the application program 1046 without reducing an operation rate of the information processing device 1010. Specifically, it is no longer necessary to perform time-consuming processing including, for example, restarting and temporarily invalidating the execution program management unit 403 to recreate the whitelist, and thereafter validating the execution program management unit 403 again. Therefore, the above-mentioned update of the software can be completely automated. As a result, the operation rate of the information processing device 1010 can be increased.

The present embodiment has described the case where the software is updated via the network as illustrated in FIG. 13. On the other hand, in a case where the software is updated via the USB memory, the system update unit 407 only needs, in S1309, to retrieve the file stored in the USB memory, read the name of the application program 1046 or OS 1041, and display the list thereof as illustrated in FIG. 9. When the input unit 401 accepts the depression of the OK button in S1310, the system update unit 407 only needs, in S1314, to copy all of the update programs (or a selected update program) from the USB memory to the SSD 104.

The present invention is not limited to the above-mentioned embodiment and includes various types of modification. The present invention is not necessarily limited to what is provided with all of the described configurations. In addition, one example configuration can be partially replaced by another example configuration. Each example configuration can be partially deleted, or can be supplemented by/exchanged for another configuration.

For example, the above-mentioned update of the software via the network and the update of the software via the USB memory may be executed in combination. Although the GET method of the HTTP is used in the update via the network to obtain the ZIP file including the update program, the method is not limited to this example, and any other method can be used to obtain the ZIP file. Furthermore, in the case where the ZIP file is obtained via the network, the update processing illustrated in FIG. 13 may be executed after determining, by executing certification on each occasion, that the software has been rightly installed. This can prevent a reduction in the operation rate of the information processing device 1010, decrease the workload that accompanies the update of the software, and prevent an unauthorized update of the software. Meanwhile, the execution program management unit 403 permits the update permission unit 4031 to execute the update of software and gives the updater authority in S1302 of FIG. 13. However, the permission or giving of the authority may be executed before starting the processing. In this case, the update process illustrated in FIG. 13 can be simplified.

According to the embodiment, a workload that accompanies an update of software can be decreased without reducing an operation rate of a device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing device comprising:
an execution program management unit that
includes an update permission unit configured to permit update of software,
is configured to permit the update permission unit to execute the update of the software, and
is configured to give, to the software, an update authority so that the update permission unit obtains permission for the update of the software; and
an update unit that
is started by the software to which the update authority has been given by the execution program management unit,
is configured to receive, from an external device, an updating file for updating the software, and
is configured to register the received updating file in a whitelist to update the software.

2. The information processing device according to claim 1, wherein the update unit updates the software after certifying that the software has been rightly installed in the information processing device.

3. The information processing device according to claim 1, wherein the external device is a server device coupled via a network or a storage medium coupled via an interface.

4. The information processing device according to claim 3, wherein the update unit displays, on a display unit, a selection screen that allows a user to select the external device, and receives the updating file from the selected external device to update the software.

5. A computer program product comprising a non-transitory computer-readable recording medium having stored therein a program that causes a computer to execute:
permitting an update permission unit, which permits update of software, to execute the update of the software;
giving, to the software, an update authority so that the update permission unit obtains permission for the update the software;
starting an update unit by the software to which the update authority has been given;
receiving, from an external device, an updating file for updating the software; and
registering the received updating file in a whitelist to update the software.
